(19) United States
(12) Patent Application Publication
(10) Pub. No.: US 2017/0079450 A1
(43) Pub. Date: Mar. 23, 2017

(54) APPARATUS AND METHOD TO FACILITATE HANGING WALL ART

(71) Applicant: Yowanda Renee Russell, Romeoville, IL (US)

(72) Inventor: Yowanda Renee Russell, Romeoville, IL (US)

(21) Appl. No.: 15/221,103

(22) Filed: Jul. 27, 2016

Related U.S. Application Data
(60) Provisional application No. 62/221,380, filed on Sep. 21, 2015.

(51) Int. Cl. A47G 1/20; B43K 8/02; B43K 29/00; A47G 1/17; A47G 1/21

(52) U.S. Cl. CPC A47G 1/205; A47G 1/20; A47G 1/17; A47G 1/21; B43K 29/00; B43K 8/02

(57) ABSTRACT

An apparatus that helps hang wall art. A clamp attachable to a hanging element of an item of wall art that has a marking implement removably attached to the clamp and a marking tip oriented towards a wall surface opposite the wall hanging element. The marking tip simply marks the spot on the wall, and if the user decides on another location, the mark can be wiped off, with no damage to the wall.

### CROSS-REFERENCE TO RELATED APPLICATION

This application claims the benefit of priority of U.S. provisional application No. 62/221,380, filed Sep. 21, 2015, the contents of which are herein incorporated by reference.

### BACKGROUND OF THE INVENTION

The present invention relates to wall art, such as framed pictures, and the like, and more particularly to an apparatus to mark a wall surface for accurately identifying the placement of a frame hanging bracket.

The typical homeowner or person who hangs an item of wall art is presented the problem of hanging the artwork in a suitable position to present a pleasing orientation of the wall art. Many times the user will select a point on the wall and sink a nail or other picture hanging device into the wall, only to be disappointed with the placement on the wall. While they may remove the hanging device and reposition it, preferably in a position that will mask the first hole. Nonetheless, the surface of the wall is left with a marred finish that must eventually be filled and perhaps repainted.

As can be seen, there is a need for a device that simply marks the spot on the wall, and if the user decides on another location, the mark can be wiped off, with no damage to the wall.

### SUMMARY OF THE INVENTION

In one aspect of the present invention, an apparatus for marking a spot on a wall surface for hanging wall art is disclosed. The apparatus includes a clip, having a pair of pivotally disposed clip arms, a grip portion at a first end of the clip arms and a clip opening portion at a second end thereof. A marking implement is attached to an outer surface a first clip arm, the wall marking implement having a marking tip oriented away from the outer surface of the clip arm. In some embodiments, the marking implement is attached proximal to the grip portion. The marking implement may be removably attached to the clip arm via a fastener, which may be a snap, a post, an adhesive, or a hook and pile fabric.

In some embodiments, the marking implement includes an interior cavity configured to receive a volume of ink in communication with the marking tip. The ink may also be carried on a porous media within the cavity. The marking implement may have a cap removably secured over the marking tip. A lanyard may also connect the cap to the marking implement. The marking implement may also be replaceable.

In other embodiments, the apparatus may also include a magnet attached to an outer surface of the second clip arm. Preferably, the magnet is attached proximal to the gripping portion of the second clip arm.

Other aspects of the invention include a method for hanging an article on a wall surface. The method includes the steps of 1) attaching a marking clip to the article; 2) positioning the article at a desired location proximal to the wall surface; and 3) positioning the article towards the wall surface such that a marking tip attached to the marking clip applies a mark to the wall surface. The marking clip may have a pair of pivotally disposed clip arms, a grip portion at a first end of the clip arms and a marking implement attached to an outer surface a first clip arm, the wall marking implement having a marking tip oriented away from the outer surface of the clip arm.

After the mark has been applied to the wall surface, the method may also include positioning the article away from the wall surface. The clip may then be removed from the article. A mounting fastener may be attached to the wall surface at the mark. The article may then be attached to the mounting fastener.

These and other features, aspects and advantages of the present invention will become better understood with reference to the following drawings, description and claims.

### BRIEF DESCRIPTION OF THE DRAWINGS

FIG. 1 is a front elevation view of an embodiment of a wall marking apparatus of the present invention.

FIG. 2 is a rear elevation view of a wall marking apparatus.

FIG. 3 is a partially exploded side elevation view of a wall marking apparatus.

FIG. 4 is a side elevation view of a wall marking apparatus.

FIG. 5 is a side elevation view of a wall marking apparatus with a cap removed from a tip of a marking implement.

FIG. 6 is a side elevation view of a wall marking apparatus in use to mark a wall surface.

FIG. 7 is a detail view of a marking implement along line 7-7 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an apparatus that simply and accurately marks a placement spot for a frame hanger on the surface of a wall, and if the user decides on another location, the mark can be wiped off, with no damage to the wall. The apparatus facilitates hanging of wall art with little to no damage to the wall or the wall art itself. Instead of making a hole in the wall and causing damage to the wall, the present invention marks the wall with a washable marker, pencil, or other removable marking implement, allowing options for the user in choosing a location for hanging an item of wall art without damaging the wall.

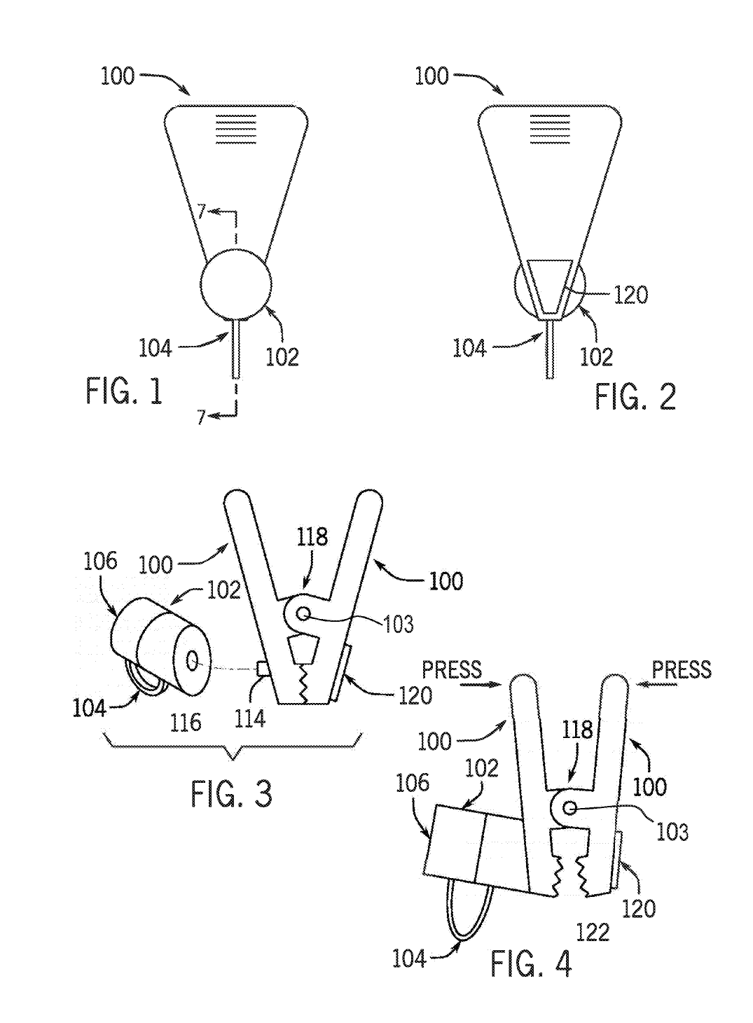

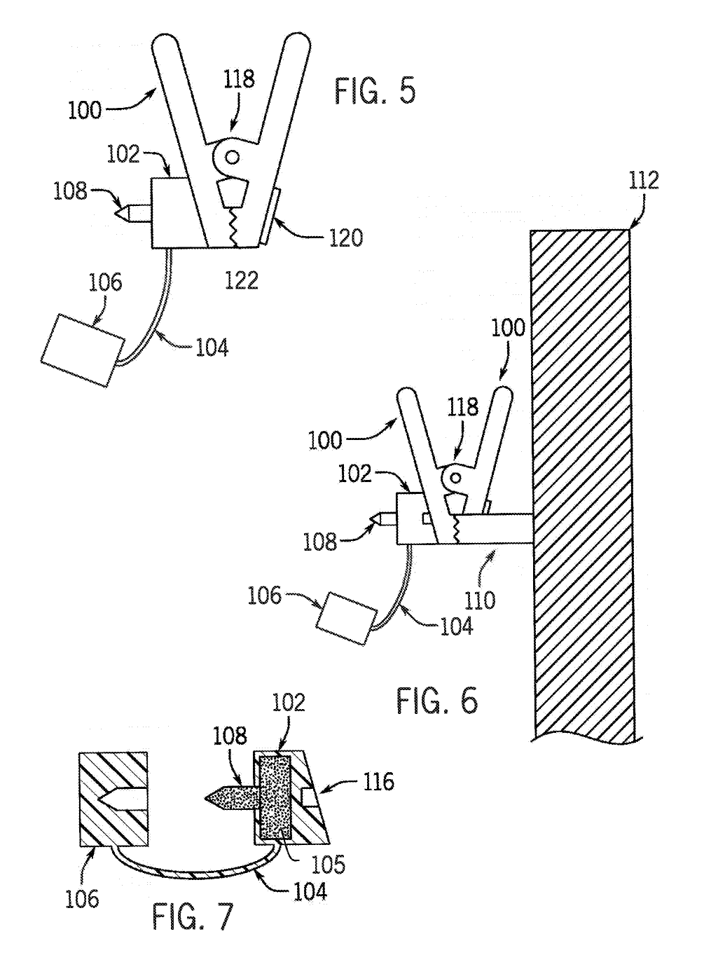

As seen in reference to FIGS. 1-6, the apparatus of the present invention includes a clip 100 with a pair of clip arms 101 & 121 pivotally disposed about a pivot pin 103. A spring 118 biases the opposed clip arms 101 & 121 in a closed position wherein opposed gripping portions 122 at a first end of the clip arms 101 & 102 permit the clip 100 to attach a variety of articles. The clip 100 is opened by operating a second, clip opening portion of the clip arms 101 & 121 to separate the gripping portions 122 from each other. In a preferred embodiment of the invention, the clip 100 operatively couples to a hook 110 or a hanging wire 110 attached to a selected piece of wall art 112.

The apparatus includes a marker 102 attached to an outer surface of a first clip arm 101 of the clip 100. The marker 102 has a marker tip 108, or similar writing implement tip, to mark a spot on the wall with no damage to the wall itself. Preferably, the marker is a non-permanent washable ink or substrate that may be readily cleaned from the surface of the wall. When the marker tip 108 is configured for providing an ink marking, the marker 102 includes an interior cavity 105 for containing a supply of ink, which may be carried on a porous media in communication with the marker tip 108.

The marker 102 may include a cap 106 that can be removed from the marker 102 after the clip 100 is attached and preliminarily positioned against a wall surface to expose the marker tip 108. Preferably, the cap 106 is connected to the marker 102 by a plastic connector 104 or lanyard. When the marker 102 has been used up, it can be replaced with another marker 102 that has a fastening point 116 defined at a second, non-marking end of the marker. The fastening point 116 may snap onto a stud 114, a snap, a hook and pile material, or other fastener attached to the clip arm 101.

In a preferred embodiment, the marker 102 is located at a clamping end of the clip 114 to ensure proper alignment of the marker tip 108 with the hanger 110 attached to the item of wall art 112. More preferably, a base of the marker 102 is configured so that the marker is oriented substantially perpendicular to a longitudinal axis of the clip 100.

To use the device, the clip 100 with the marker 102 attaches to the wall art hook 110. When a location is found for hanging the wall art, the cap 106 is removed, exposing the marker tip 108, and the user presses the wall art 112 with the exposed marker tip 108 against the wall, leaving a washable mark, and no damage. If the user changes their mind about the mark that was made, the mark washes off, leaving the wall undamaged. But once the user decides on a location and has made the mark, the cap 106 can be put back on, and the clip 100 removed from the wall art hook 110. The user is then free to apply nails or some other type of hanging apparatus to hang the wall art 112 on the wall.

The clip 100 may preferably be made from plastic material with a metal spring 118 in the middle, and the arms on a top portion of the clip would be wide enough so the user is able to securely grip it. The bottom inside portion of the clip 100 where the clip 100 gripping portion 122 attaches to the wall art hook 110 may preferably have ridges that help to secure the clip 100 to the hook 110 while in use. The marker 102, which is also preferably made of plastic, has a removable, attached cap 106, with a marker, or writing tip 108 that is secured inside one end of the marker 102. The marker 102 would be made to snap onto a stud, post, or snap 114 on the bottom outside portion of the clip 100, allowing for the replacement of old markers 102 with new markers.

The clip 100 may also be provided with a magnet 120 attached to an exterior surface of the second gripping arm 120 proximal to the gripping portion 122. The magnet 120 may be utilized to attach the clip 100 to a ferrous wall art hook 110, or alternatively a back surface of a ferrous item of wall art 112. The magnet 120 may also be utilized to store the clip 100 in a convenient location, such as a refrigerator, where the clip 100 may be utilized for hanging items, such as a child's artwork, family schedules, photographs, and the like.

It should be understood, of course, that the foregoing relates to exemplary embodiments of the invention and that modifications may be made without departing from the spirit and scope of the invention as set forth in the following claims.

What is claimed is:

1. An apparatus for marking a spot on a wall surface for hanging wall art, comprising:
a clip, having a pair of pivotally disposed clip arms, a grip portion at a first end of the clip arms and a clip opening portion at a second end thereof,
a marking implement attached to an outer surface a first clip arm, the wall marking implement having a marking tip oriented away from the outer surface of the clip arm.

2. The apparatus of claim 1, wherein the marking implement is attached proximal to the grip portion.

3. The apparatus of claim 2, wherein the marking implement is removably attached to the clip arm via a fastener.

4. The apparatus of claim 3, wherein the fastener is one of a snap, a post, an adhesive, or a hook and pile fabric.

5. The apparatus of claim 4, wherein the marking implement comprises an interior cavity configured to receive a volume of ink in communication with the marking tip.

6. The apparatus of claim 5, wherein the ink is carried on a porous media within the cavity.

7. The apparatus of claim 6, further comprising:
a cap removably secured over the marking tip.

8. The apparatus of claim 7, further comprising:
a lanyard connecting the cap to the marking implement.

9. The apparatus of claim 6, further comprising:
a magnet attached to an outer surface of the second clip arm.

10. The apparatus of claim 8, wherein the magnet is attached proximal to the gripping portion of the second clip arm.

11. The apparatus of claim 6, wherein the marking implement is replaceable.

12. A method for hanging an article on a wall surface, comprising:
attaching a marking clip to the article;
positioning the article at a desired location proximal to the wall surface;
positioning the article towards the wall surface such that a marking tip attached to the marking clip applies a mark to the wall surface.

13. The method of claim 12, wherein the marking clip comprises:
a pair of pivotally disposed clip arms, a grip portion at a first end of the clip arms, and
a marking implement attached to an outer surface a first clip arm, the wall marking implement having a marking tip oriented away from the outer surface of the clip arm.

14. The method of claim 12, further comprising:
positioning the article away from the wall surface.

15. The method of claim 14, further comprising:
removing the marking clip from the article.

16. The method of claim 15, further comprising:
attaching a mounting fastener to the wall surface at the mark.

17. The method of claim 16, further comprising:
attaching the article to the mounting fastener.
